(19) United States
(12) Patent Application Publication
(10) Pub. No.: US 2015/0317166 A1
(43) Pub. Date: Nov. 5, 2015

(54) ELECTRONIC DEVICE AND OPEN DETECTING DEVICE FOR ENCLOSURE

(71) Applicants: HONG FU JIN PRECISION INDUSTRY (WuHAN) CO., LTD., Wuhan (CN); HON HAI PRECISION INDUSTRY CO., LTD., New Taipei (TW)

(72) Inventors: JIE MIN, Wuhan (CN); CHUN-SHENG CHEN, New Taipei (TW)

(21) Appl. No.: 14/616,023

(22) Filed: Feb. 6, 2015

(30) Foreign Application Priority Data
Apr. 30, 2014 (CN) 201410179687.X

(51) Int. Cl. G06F 9/44; G06F 1/16; G06F 9/445; G06F 1/18

(52) U.S. Cl. CPC G06F 9/442; G06F 1/182; G06F 1/1633; G06F 9/44505

(57) ABSTRACT

An electronic device includes an enclosure, a cover for closing the enclosure, a detecting module, a timer, and a system controller. The detecting module can detect if the cover is opened relative to the enclosure. The timer is coupled to the detecting module. The system controller is coupled to the timer. The timer is configured to time an open period of the cover. The system controller can shut down an operating system of the electronic device when the open period exceeds a predefined period.

### CROSS-REFERENCE TO RELATED APPLICATIONS

This application claims priority to Chinese Patent Application No. 201410179687.X filed on Apr. 30, 2014, the contents of which are incorporated by reference herein.

### FIELD

The subject matter herein generally relates to an electronic device and an open detecting device for an enclosure.

### BACKGROUND

An electronic device includes an enclosure for protecting internal electronic components, such as CPU, memory, display card, and hard disk, from unauthorized access.

### BRIEF DESCRIPTION OF THE DRAWINGS

Implementations of the present technology will now be described, by way of example only, with reference to the attached figures.

FIG. 1 is a diagrammatic view of an embodiment of an electronic device.

FIG. 2 is a circuit view of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts can be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

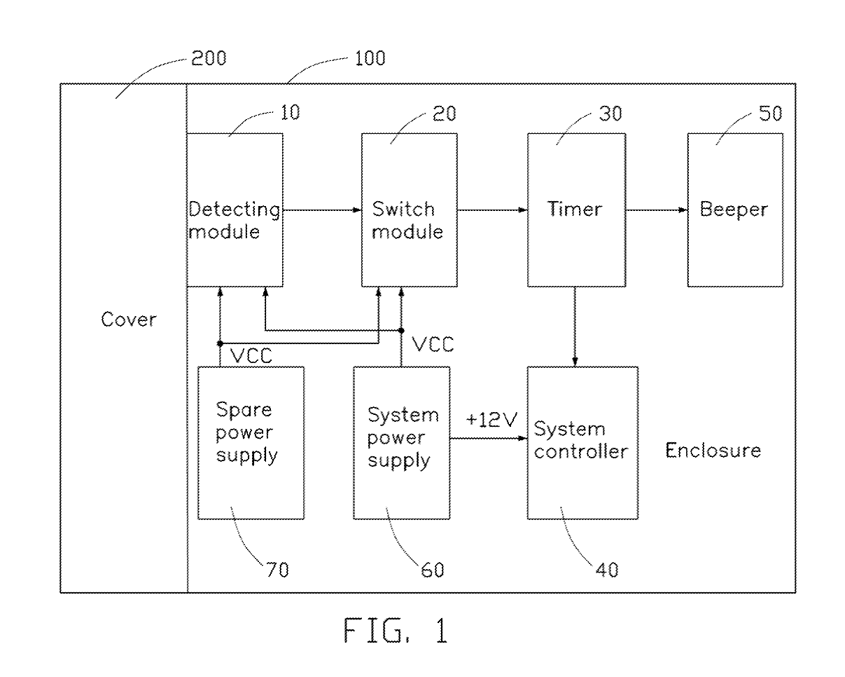

FIG. 1 illustrates a diagrammatic view of an electronic device in one embodiment. The electronic device includes an open detecting device. The open detecting device includes a detecting module 10, a switch module 20, a timer 30, a system controller 40, and a beeper 50. The electronic device can be a server, a laptop computer, a desktop computer, a tablet computer, an all-in-one computer, a smart TV, or a set-box-top. The electronic device further includes an enclosure 100 and a cover 200 for closing the enclosure 100. The open detecting device can detect if the cover 200 is opened relative to the enclosure 100. The switch module 20, a timer 30, and the system controller 40 are located in the enclosure 100. The detecting module 10 can be installed on an edge of the enclosure to detect if the cover 20 is mounted on or detached from the enclosure 100. The electronic device further includes a system power supply 60 and a spare power supply 70. When a system of the electronic device, such as an operating system, is on, the detecting module 10, the timer 20 and the system controller 40 are supplied by the system power supply 60. When the system is off, the detecting module 10 and the timer 30 are supplied by the spare power supply 70.

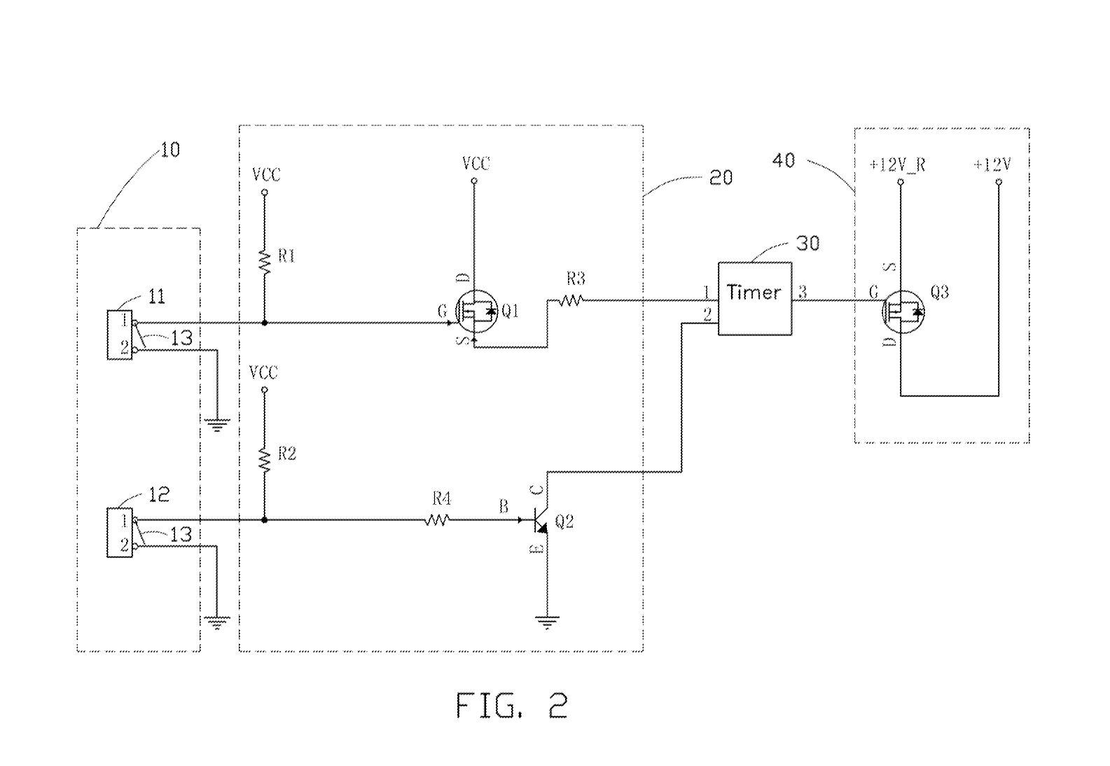

FIG. 2 illustrates a circuit view of the electronic device in one embodiment. The detecting module 10 includes a first detecting member 11 and a second detecting member 12. The first detecting member 11 and the second detecting member 12 can be installed on the enclosure 100. Each of the first detecting member 11 and the second detecting member 12 includes a first pin 1, a second pin 2, and a conducting strip 13, the first pin 1 and the second pin 2 can be located on the enclosure 100. When the cover 200 closes the enclosure 100; the conducting strip 13 conducts the first pin 1 to the second pin 2. When the cover 200 is opened, the first pin 1 is disconnected from the second pin 2. The first pin 1 of the first detecting member 11 is coupled to a VCC through a first resistor R1. The VCC can provide +5V direct current from the system power supply 60 or the spare power supply 70. The second pin 2 of the first detecting member 11 is grounded. The first pin 1 of the second detecting member 12 is coupled to the VCC through a second resistor R2. The second pin 2 of the second detecting member 12 is grounded.

The switch module 20 includes a first transistor Q1 and a second transistor Q2. The first transistor Q1 can be an n-channel enhancement field effect transistor (FET). The second transistor Q2 can be an npn transistor.

The first transistor Q1 is coupled to the first detecting member 11 and the timer 30. A gate terminal G of the first transistor Q1 is coupled to the first pin 1 of the first detecting member 11. A drain terminal D of the first detecting member 11 is coupled to the VCC. A source terminal S of the first transistor Q1 is coupled to a first pin 1 of the timer 30. The second transistor Q2 is coupled to the second detecting member 12 and the timer 30. A base terminal B of the second transistor Q2 is coupled to the first pin 1 of the second detecting member 12. A collector terminal C of the second detecting member Q2 is coupled to a second pin of the timer 30. An emitter terminal E of the second transistor Q2 is grounded. The timer 30 further includes a third pin 3 coupled to the system controller 40.

The system controller 40 includes a third transistor Q3. The third transistor Q3 can be a p-channel enhancement FET. A gate terminal G of the third transistor Q3 is coupled to the pin 3 of the timer 30. A source terminal S is coupled to a +12V power supply. A drain terminal D is coupled to inner electronic components of the electronic device to supply +12V power supply.

When the cover 200 is removed from the enclosure 100, the pin 1 and pin 2 of the first detecting member 11 are disconnected, the pin 1 of the first detecting member 11 receives high level signal from the VCC. The first transistor Q1 is turned on. The source terminal S of the first transistor Q1 sends high level signal to the first pin 1 of the timer 30. The pin 1 and pin 2 of the second detecting member 12 are disconnected, the pin 1 of the second detecting member 12 receives high level signal from the VCC. The second transistor Q2 is turned on. The collector terminal C of the second transistor Q2 is low level signal, and the second pin 2 of the timer 30 receives low level signal. The timer 30 starts when detecting the high level signal from the pin 1. The timer 30 can send a control signal to the system controller 40 when duration of the high level signal exceeds a predefined period, such as 2 minutes. The pin 3 of the timer 30 outputs high level signal to the third transistor Q3. The third transistor Q3 is turned off when receiving the high level signal. Power supply can output from the drain terminal D of the third transistor Q3 is cut off.

When the cover 200 is mounted to the enclosure 100. The first pins 1 and the second pins 2 of the first detecting member 11 and second detecting member are coupled through the conducting strips 13. The first pins 1 of the first detecting member 11 and second detecting member 12 are grounded. The first transistor Q1 and the second transistor Q2 are turned off. The first pin 1 and the second pin 2 of the timer 30 are void. The timer 30 is turned off. The third pin 3 of the timer 30 sends low level signal. The third transistor Q3 is turned on. Power supply can output from the drain terminal D of the third transistor Q3 to supply the system.

In other embodiments, the timer 30 can be also coupled to a beeper 50. The beeper 40 can beep when an open period of the cover 200 exceeds the predefined period.

The embodiments shown and described above are only examples. Many details are often found in the art such as the other features of an electronic device or an open detecting device. Therefore, many such details are neither shown nor described. Even though numerous characteristics and advantages of the present technology have been set forth in the foregoing description, together with details of the structure and function of the present disclosure, the disclosure is illustrative only, and changes can be made in the details, including in matters of shape, size and arrangement of the parts within the principles of the present disclosure up to, and including, the full extent established by the broad general meaning of the terms used in the claims. It will therefore be appreciated that the embodiments described above can be modified within the scope of the claims.

What is claimed is:

1. An electronic device comprising:
an enclosure forming at least one opening;
a cover for the at least one opening of the enclosure;
a detecting module for detecting if the cover is opened relative to the opening;
a timer coupled to the detecting module and being configured to time an open period of the cover relative to the opening; and
a system controller coupled to the timer and being configured to shut down an operating system of the electronic device when the open period exceeds a predefined period.

2. The electronic device of claim 1, wherein the detecting module comprises a first detecting member, the first detecting member comprises a first pin, a second pin, and a conducting strip, when the cover closes the enclosure, the conducting strip conducts the first pin to the second pin; when the cover is opened, the first pin is disconnected from the second pin.

3. The electronic device of claim 2, further comprising a first transistor, wherein the first transistor is coupled to the first detecting member and the timer, a gate terminal of the first transistor is coupled to the first pin of the first detecting member, a drain terminal of the first detecting member is coupled to a direct current power supply, a source terminal of the first transistor is coupled to the timer, and the second pin of the first detecting member is grounded.

4. The electronic device of claim 3, wherein the timer is configured to time when the timer receives a high level signal from the first transistor and output a control signal to the system controller when duration of the high level signal exceeds the predefined period, and the system controller is configured to shut down the operating system when the system controller receives the control signal.

5. The electronic device of claim 4, wherein the system controller comprises a P-channel MOSFET, and the first transistor is a N-channel enhancement FET.

6. The electronic device of claim 3, wherein the detecting module further comprises a second detecting member, the second detecting member comprises a first pin, a second pin, and a conducting strip, the first pin and the second pin are located on the enclosure, when the cover closes the enclosure, the conducting strip conducts the first pin to the second pin, when the cover is opened, the first pin is disconnected from the second pin.

7. The electronic device of claim 6, further comprising a second transistor, wherein the second transistor is coupled to the second detecting member and the timer, a base terminal of the second transistor is coupled to the first pin of the second detecting member, a collector terminal of the second detecting member is coupled to the timer, an emitter terminal of the second transistor is grounded, and the second pin of the second detecting member is grounded.

8. The electronic device of claim 7, wherein the second transistor is an npn transistor.

9. The electronic device of claim 1, further comprising a beeper coupled to the timer, wherein the beeper is configured to beep when the open period exceeds the predefined period.

10. The electronic device of claim 1, further comprising a system power supply and a spare power supply, when the operating system is on, the detecting module, the timer and the system controller are supplied by the system power supply, and when the operating system is off, the detecting module and the timer are supplied by the spare power supply.

11. An open detecting device for an enclosure of an electronic device comprising:
a detecting module for detecting if a cover is opened relative to the enclosure;
a timer coupled to the detecting module; and
a system controller coupled to the timer;
wherein the timer is configured to time an open period of the cover, the system controller is configured to shut down an operating system of the electronic device when the open period exceeds a predefined period.

12. The open detecting device of claim 11, wherein the detecting module comprises a first detecting member, the first detecting member comprises a first pin, a second pin, and a conducting strip, when the cover closes the enclosure, the conducting strip conducts the first pin to the second pin; when the cover is opened, the first pin is disconnected from the second pin.

13. The open detecting device of claim 12, further comprising a first transistor, wherein the first transistor is coupled to the first detecting member and the timer, a gate terminal of the first transistor is coupled to the first pin of the first detecting member, a drain terminal of the first detecting member is coupled to a direct current power supply, a source terminal of the first transistor is coupled to the timer, and the second pin of the first detecting member is grounded.

14. The open detecting device of claim 13, wherein the timer is configured to time when the timer receives a high level signal from the first transistor and output a control signal to the system controller when duration of the high level signal exceeds the predefined period, and the system controller is configured to shut down the operating system when the system controller receives the control signal.

15. The open detecting device of claim 14, wherein the system controller comprises a P-channel MOSFET, and the first transistor is a N-channel enhancement FET.

16. The open detecting device of claim 13, wherein the detecting module further comprises a second detecting member, the second detecting member comprises a first pin, a second pin, and a conducting strip, the first pin and the second pin are located on the enclosure, when the cover closes the enclosure, the conducting strip conducts the first pin to the second pin, when the cover is opened, the first pin is disconnected from the second pin.

17. The open detecting device of claim 16, further comprising a second transistor, wherein the second transistor is coupled to the second detecting member and the timer, a base terminal of the second transistor is coupled to the first pin of the second detecting member, a collector terminal of the second detecting member is coupled to the timer, an emitter terminal of the second transistor is grounded, and the second pin of the second detecting member is grounded.

18. The open detecting device of claim 17, wherein the second transistor is an pnp transistor.

19. The open detecting device of claim 11, further comprising a beeper coupled to the timer, wherein the beeper is configured to beep when the open period exceeds the predefined period.

20. The open detecting device of claim 11, further comprising a system power supply and a spare power supply, when the operating system is on, the detecting module, the timer and the system controller are supplied by the system power supply, and when the operating system is off, the detecting module and the timer are supplied by the spare power supply.
